(19) United States
(12) Patent Application Publication
(10) Pub. No.: US 2024/0012356 A1
(43) Pub. Date: Jan. 11, 2024

(54) IMAGE FORMING APPARATUS

(71) Applicant: KYOCERA Document Solutions Inc., Osaka (JP)

(72) Inventor: Hiroki TAKEHANA, Osaka (JP)

(73) Assignee: KYOCERA Document Solutions Inc., Osaka (JP)

(21) Appl. No.: 18/265,153

(22) PCT Filed: Jul. 29, 2022
(86) PCT No.: PCT/JP2022/029233

§ 371 Date: Jun. 2, 2023

(30) Foreign Application Priority Data
Aug. 6, 2021 (JP) 2021-129914

(51) Int. Cl. G03G 15/00

(52) U.S. Cl. CPC G03G 15/505; G03G 15/6529

(57) ABSTRACT

An image forming apparatus includes: a conveyance device; an image forming device that forms an image on a recording paper sheet conveyed by the conveyance device; and a controller that determines a conveyance speed for the recording medium in accordance with a predetermined condition and allows the conveyance device to convey the recording medium at the determined conveyance speed for the recording medium. In allowing the conveyance device to convey the recording paper sheet and subsequently allowing the conveyance device to convey a slip sheet, the controller allows the conveyance device to convey the slip sheet at the same speed as the determined conveyance speed for the recording paper sheet.

### TECHNICAL FIELD

The present invention relates to image forming apparatuses and particularly relates to a technique for setting the conveyance speed for a slip sheet.

### BACKGROUND ART

There is known a technique for setting the conveyance speed for a slip sheet to be inserted after every predetermined number of recording paper sheets in a print job. For example, Patent Literature 1 discloses a technique in which when, in inserting a slip sheet, an output parameter of a print job for the next recording paper sheet is obtained before a predetermined elapsed time reaches a threshold value, the conveyance speed for the slip sheet is set at the same speed as the conveyance speed for a recording paper sheet, whereas when, in inserting a slip sheet, the elapsed time reaches the threshold value before an output parameter of the next print job is obtained, the conveyance speed for the slip sheet is set at a maximum conveyance speed.

### CITATION LIST

### Patent Literature

Patent Literature 1: JP-A-2014-74763

### SUMMARY OF INVENTION

In the technique disclosed in Patent Literature 1, it is sometimes necessary to do control for changing the conveyance speed in conveying a slip sheet after the conveyance of recording paper sheets, which may decrease the print productivity.

The present invention has been made in view of the foregoing circumstances and has an object of preventing decrease in print productivity by reducing the number of controls for changing the conveyance speed.

An image forming apparatus according to an aspect of the present invention includes: a conveyance device that coveys a recording medium; an image forming device that forms, on the recording medium conveyed by the conveyance device, an image in accordance with a print job for the recording medium; and a controller that determines a conveyance speed for the recording medium in accordance with a predetermined condition and allows the conveyance device to convey the recording medium at the determined conveyance speed for the recording medium. In allowing the conveyance device to convey the recording medium and subsequently allowing the conveyance device to convey a predetermined insert medium, the controller allows the conveyance device to convey the insert medium at the same speed as the determined conveyance speed for the recording medium.

### Advantageous Effects of Invention

Since, in the present invention, the conveyance speed for an insert medium is set at the same speed as the conveyance speed for the recording medium conveyed previously, there is no need to do control for changing the conveyance speed in conveying the insert medium after the conveyance of the recording medium. Therefore, the number of controls for changing the conveyance speed can be reduced and, as a result, the decrease in print productivity can be prevented.

### BRIEF DESCRIPTION OF DRAWINGS

FIG. 1 is a frontal cross-sectional view showing the structure of an image forming apparatus.

FIG. 2 is a block diagram showing an internal configuration of the image forming apparatus.

FIG. 3A is a flowchart showing conveyance speed setting processing.

FIG. 3B is a flowchart showing the conveyance speed setting processing.

### DESCRIPTION OF EMBODIMENTS

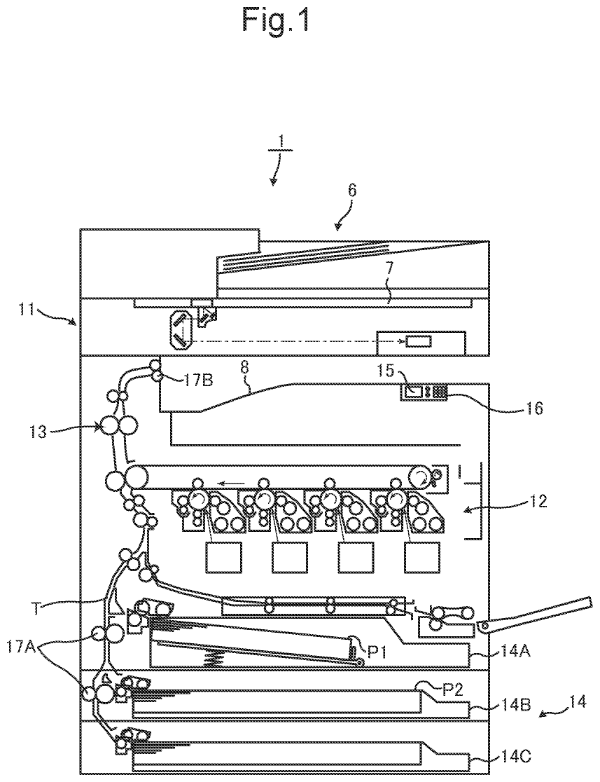

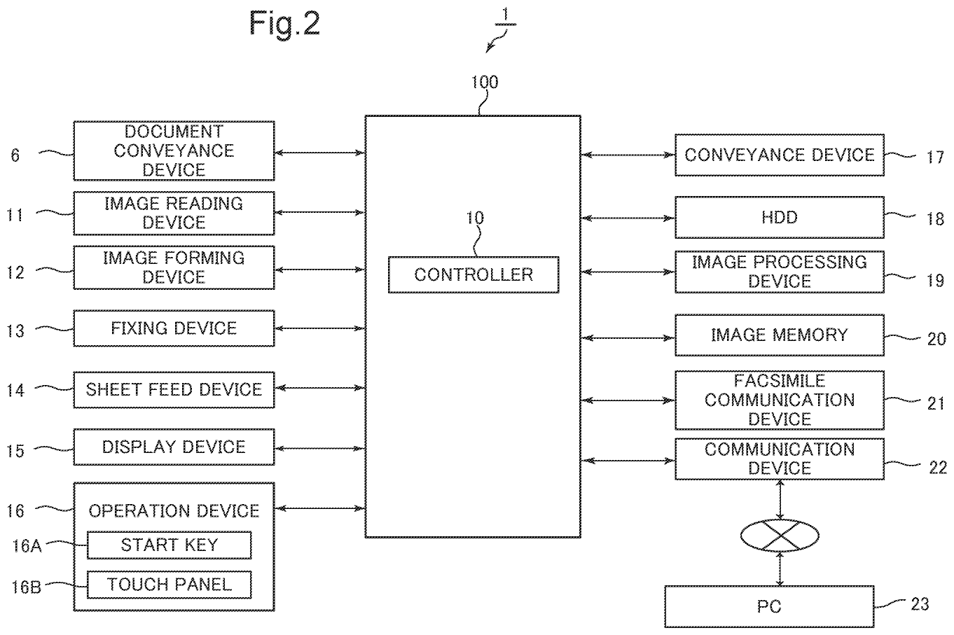

Hereinafter, a description will be given of an image forming apparatus according to one embodiment of the present invention with reference to the drawings. FIG. 1 is a frontal cross-sectional view showing the structure of the image forming apparatus according to the one embodiment of the present invention. FIG. 2 is a block diagram showing an internal configuration of the image forming apparatus.

With reference to FIGS. 1 and 2, the image forming apparatus 1 is a multifunction peripheral having a plurality of functions, such as a copy function, a transmission function, a print function, and a facsimile function. A housing of the image forming apparatus 1 contains a plurality of devices for use in implementing various functions of the image forming apparatus 1. For example, the housing contains an image reading device 11, an image forming device 12, a fixing device 13, a sheet feed device 14, and so on.

The image forming apparatus 1 includes a control device 100. The control device 100 includes a processor, a RAM (random access memory), a ROM (read only memory), and so on. The processor is, for example, a CPU (central processing unit), an MPU (micro processing unit), an ASIC (application specific integrated circuit) or the like. The RAM is an example of a storage device defined in Claims.

When a control program stored in the ROM or an HDD 18 is executed by the above processor, the control device 100 functions as a controller 10. Alternatively, the controller 10 may not be implemented by the operation of the processor in accordance with the above control program, but may be constituted by a logic circuit. The controller 10 governs the overall control of the image forming apparatus 1. More specifically, the controller 10 controls the operations of the devices constituting the image forming apparatus 1 and communications of the image forming apparatus 1 with a PC (personal computer) 23 and others connected via a network.

In addition, by operating in accordance with a setting program to be described hereinafter, the controller 10 executes conveyance speed setting processing for determining the conveyance speed S1 for a recording paper sheet P1 in accordance with a predetermined condition, allowing a conveyance device 17 to convey the recording paper sheet P1 at the determined conveyance speed S1 for the recording paper sheet P1, and, in allowing the conveyance device 17 to convey the recording paper sheet P1 and subsequently allowing the conveyance device 17 to convey a slip sheet P2, allowing the conveyance device 17 to convey the slip sheet P2 at the same speed as the determined conveyance speed S1 for the recording paper sheet P1.

The control device 100 is electrically connected to a document conveyance device 6, the image reading device 11, the image forming device 12, the fixing device 13, the sheet feed device 14, a display device 15, an operation device 16, the conveyance device 17, the HDD 18, an image processing device 19, an image memory 20, a facsimile communication device 21, a communication device 22, and so on.

The image reading device 11 is an ADF (auto document feeder) including: the document conveyance device 6 that conveys sheets of original document loaded on a document loading table; and a scanner that optically reads a sheet of original document conveyed by the document conveyance device 6 or a sheet of original document placed on a platen glass 7. The image reading device 11 irradiates the sheet of original document with light from a lighting part, receives light reflected from the sheet of original document on a CCD (charge-coupled device) sensor to read an image of the sheet of original document, and generates image data representing the image of the sheet of original document.

The image forming device 12 includes a plurality of photosensitive drums, associated charging devices, associated exposure devices, associated developing devices, and associated transfer devices. Based on the image data generated by the image reading device 11 or image data or the like input through the communication device 22, the image forming device 12 forms an image consisting of a toner image on a recording paper sheet P1 being conveyed along a conveyance path T by the conveyance device 17, in accordance with a print job for the recording paper sheet P1.

The fixing device 13 applies heat and pressure to the recording paper sheet P1 bearing the toner image formed by the image forming device 12, thus fixing the toner image on the recording paper sheet P1. The recording paper sheet P1 bearing the toner image fixed by the fixing device 13 is discharged to a sheet output tray 8.

The sheet feed device 14 includes a manual feed tray, a sheet feed cassette 14A, a sheet feed cassette 14B, and a sheet feed cassette 14C. The sheet feed device 14 delivers a recording paper sheet P1 or a slip sheet P2 to the conveyance path T by pulling out recording paper sheets P1 or slip sheets P2 accommodated in the sheet feed cassettes 14A to 14C and the manual feed tray sheet by sheet with their respective pick-up rollers and feeding forward the sheet to the conveyance path T.

In this embodiment, it is assumed that, as shown in FIG. 1, the sheet feed cassette 14A accommodates recording paper sheets P1 to be subjected to image formation and the sheet feed cassette 14B accommodates slip sheets P2. The slip sheet P2 is an example of an insert medium defined in Claims.

The display device 15 is a display device composed of a liquid crystal display, an organic EL (organic light-emitting diode) display or the like. The display device 15 displays, under the control of the controller 10, various screen images related to the various functions executable by the image forming apparatus 1.

The operation device 16 includes a plurality of hard keys, including a Start key 16A for use in giving an instruction to start executing various types of processing. The operation device 16 further includes a touch panel 16B superposed on the top of the display device 15. The user inputs through the operation device 16 various information, including instructions for the various functions executable by the image forming apparatus 1. The operation device 16 is an example of an input device defined in Claims.

The conveyance device 17 includes conveyance roller pairs 17A, an ejection roller pair 17B, other rollers, and a conveyance motor connected to the conveyance roller pairs 17A, the ejection roller pair 17B, and the other rollers. The controller 10 drives the conveyance motor to rotate the conveyance roller pairs 17A, the ejection roller pair 17B, and the other rollers, thus allowing the rollers to convey along the conveyance path T a recording paper sheet P1 or a slip sheet P2 fed by the sheet feed device 14.

The HDD 18 is a large storage device for use in storing various types of data, including image data generated by the image reading device 11. The HDD 18 holds various control programs for implementing general operations of the image forming apparatus 1. The HDD 18 holds, as one of the various control programs, a setting program for executing conveyance speed setting processing according to the one embodiment of the present invention.

The HDD 18 previously stores sheet type information indicating respective values of conveyance speeds associated with the sheet types of recording paper sheet P1 and slip sheet P2. Herein, it is assumed that the HDD 18 stores a value “100” mm/sec associated with a “plain paper sheet” and a value “70” mm/sec associated with a “heavy paper sheet”.

The image processing device 19 performs, as necessary, image processing of image data generated by the image reading device 11. The image memory 20 includes a region that temporarily stores image data generated by the image reading device 11. The facsimile communication device 21 performs connection to a public line and sends and receives image data to and from other facsimile devices via the public line.

The communication device 22 includes a communication module, such as a LAN (local area network) board. The image forming apparatus 1 performs data communications through the communication device 22 with the PC 23 and so on connected thereto via the network.

Each of the devices constituting the image forming apparatus 1 is connected to a power supply and operates on electric power supplied from the power supply.

[Operations of Image Forming Apparatus 1]

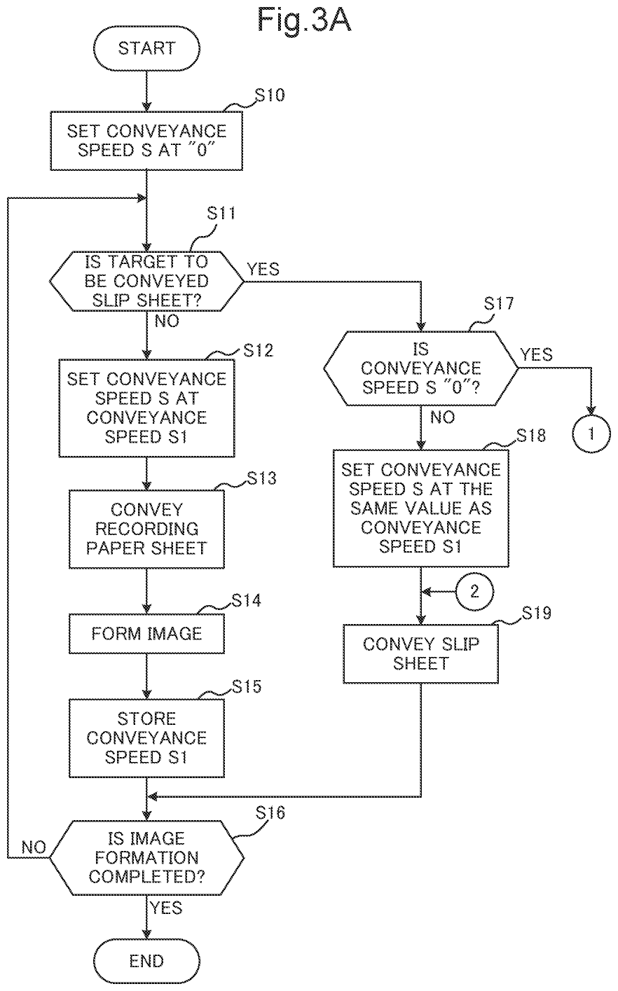

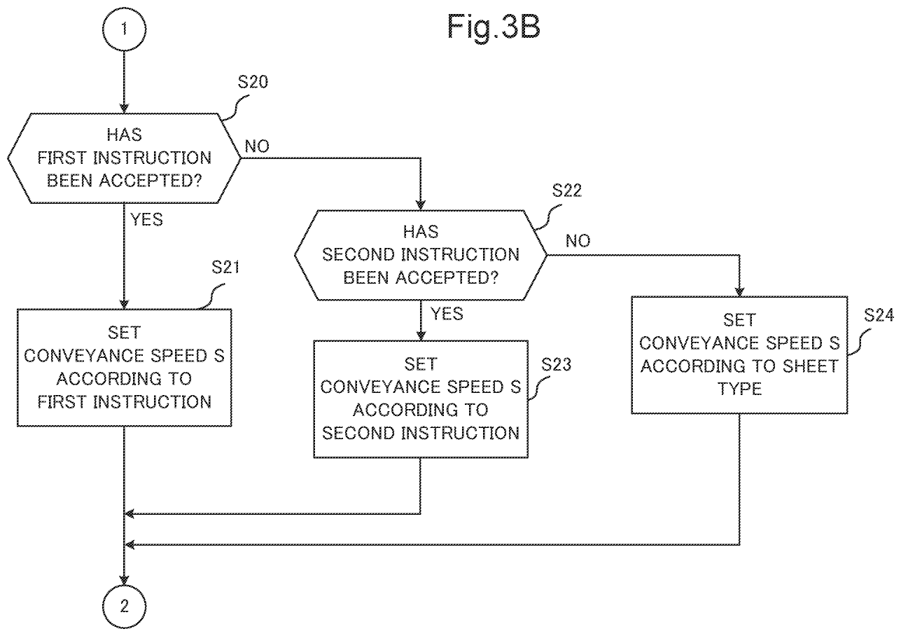

FIGS. 3A and 3B are flowcharts showing conveyance speed setting processing. A description will be given below of the operation of the image forming apparatus 1 in executing the conveyance speed setting processing with reference to FIGS. 3A and 3B and so on. In the following description, it is assumed that the image forming apparatus 1 is already in a power-on state.

(1) When a Slip Sheet P2 is Conveyed after the Conveyance of a Recording Paper Sheet P1

It is assumed that the user has input through the touch panel 16B an instruction to select a copy function and has loaded ten sheets of original document on the document loading table of the document conveyance device 6. Furthermore, it is assumed that, through the touch panel 16B, the user has input as a print job print information indicating at least a number of copies, “1”, a sheet type of recording paper sheet P1, “plain paper sheet”, an instruction to insert a slip sheet P2 after every two recording paper sheets P1, and a sheet type of slip sheet P2, “heavy paper sheet”, and has pressed the Start key 16A.

When detecting the pressing of the Start key 16A, the controller 10 allows the image reading device 11 to read the sheets of original document conveyed sequentially sheet by sheet by the document conveyance device 6 and generate image data representing document images of ten pages, and starts the execution of the conveyance speed setting processing shown in FIGS. 3A and 3B. When starting the conveyance speed setting processing, the controller 10 first sets the current conveyance speed S in the conveyance device 17 at “0” mm/sec (step S10).

After the processing in step S10, the controller 10 determines whether or not the target to be conveyed is a slip sheet P2 (step S11). In this case, since the controller 10 has accepted an instruction to insert a slip sheet P2 after every two recording paper sheets P1, the controller 10 sets, as a sheet feed cassette from which a sheet is to be fed at the beginning, i.e., first, the sheet feed cassette 14A accommodating recording paper sheets Pb. Therefore, the controller 10 determines that the target to be conveyed is not a slip sheet P2 (NO in step S11), determines the conveyance speed S1 for the recording paper sheet P1 in accordance with the predetermined condition, and sets the current conveyance speed S in the conveyance device 17 at the determined conveyance speed S1 (step S12).

At this time, when having not previously accepted through the operation device 16 a first instruction for setting a predetermined mode requiring a change in the conveyance speed S1 for the recording paper sheet P1, the controller 10 determines the conveyance speed S1 for the recording paper sheet P1 according to the print information indicated in the print job for the recording paper sheet P1.

The method for determining the conveyance speed S1 for the recording paper sheet P1 according to the print information is not particularly limited so long as it is a general method, but, in this case, the controller 10 determines the conveyance speed S1 for the recording paper sheet P1 according to the print information indicating the sheet type. In this case, since the controller 10 has not accepted the first instruction through the operation device 16, it determines, using the sheet type information stored in the HDD 18, the conveyance speed S1 for the recording paper sheet P1 to be “100” mm/sec associated with the “plain paper sheet”.

When having previously accepted the first instruction through the operation device 16, the controller 10 determines the conveyance speed S1 for the recording paper sheet P1 to be a speed associated with the mode indicated by the first instruction. The type of the predetermined mode is not particularly limited, but, in this embodiment, the predetermined mode is assumed to be any one of: a half-speed mode for setting the conveyance speed S1 at a half speed; a banner mode for setting the conveyance speed S1 at the half speed in conveying a long sheet; a cooling mode for setting the conveyance speed S1 at the half speed by way of cooling when the temperature in the apparatus becomes high; a quiet mode for setting the conveyance speed S1 at the half speed for the purpose of quiet image formation; and a glossy mode for setting the conveyance speed S1 at the half speed for the purpose of improving the glossiness of the image. The half speed refers to half the conveyance speed S1 for the recording paper sheet P1 determined according to the print information indicated in the print job for the recording paper sheet P1.

After the processing in step S12, the controller 10 allows the conveyance device 17 to convey the recording paper sheet P1 at the set conveyance speed S, i.e., the conveyance speed S1 for the recording paper sheet P1 (step S13). More specifically, the controller 10 allows the sheet feed device 14 to pull out the recording paper sheet P1 from the sheet feed cassette 14A using the pick-up roller and feed forward it to the conveyance path T. The controller 10 allows the conveyance device 17 to convey the fed recording paper sheet P1 at the set conveyance speed S (“100” mm/sec in this case) along the conveyance path T.

After the processing in step S13, the controller 10 allows the image forming device 12 and so on to form a document image (a document image of the first page in this case) on the recording paper sheet P1 being conveyed (step S14). After the processing in step S14, the controller 10 allows the RAM to store the determined value of the conveyance speed S1 for the recording paper sheet P1 (step S15). After the processing in step S15, because this time is just after the formation of the document image of the first page, the controller 10 determines that the whole process of image formation based on the print job has not been completed (NO in step S16), and goes to the processing in step S11.

The controller 10 further executes the processing in steps S11 to S15 in the same manner as described above to form a document image of the second page on a second recording paper sheet P1. After the processing in step S15, because this time is just after the formation of the document image of the second page, the controller 10 determines that the whole process of image formation based on the print job has not been completed (NO in step S16), and goes to the processing in step S11. In this case, since the controller 10 has accepted the instruction to insert a slip sheet P2 after every two recording paper sheets P1, the controller 10 sets, as a sheet feed cassette from which a sheet is to be fed next, i.e., third, the sheet feed cassette 14B accommodating slip sheets P2.

Therefore, the controller 10 determines, in step S11, that the target to be conveyed is a slip sheet P2 (YES in step S11), and determines whether or not the current conveyance speed S1 in the conveyance device 17 is set at “0” mm/sec (step S17). In this case, since the controller 10 sets the conveyance speed S at “100” mm/sec which is the conveyance speed S1 for the recording paper sheet P1, it determines that the conveyance speed S is not set at “0” mm/sec (NO in step S17), and sets the conveyance speed S at the same value as the conveyance speed S1 for the recording paper sheet P1, which is stored in the RAM (step S18). In this manner, the controller 10 determines the conveyance speed for the slip sheet P2 according to the conveyance speed S1 for the recording paper sheet P1 which is stored in the RAM.

After the processing in step S18, the controller 10 allows the conveyance device 17 to convey the slip sheet P2 at the set conveyance speed S, i.e., the same speed (“100” mm/sec in this case) as the conveyance speed S1 for the recording paper sheet P1 having been conveyed previously (step S19). In allowing the conveyance device 17 to convey the slip sheet P2, the controller 10 does not allow the image forming device 12 and so on to execute image formation processing.

After the conveyance of the slip sheet P2, the controller 10 determines that the whole process of image formation based on the print job has not been completed (NO in step S16), and goes to the processing in step S11. Thereafter, the controller 10 repeats the processing in steps S11 to S19 in the same manner as described above to finally create a printed copy in which document images of the first to tenth pages are formed on the first to tenth recording paper sheets P, respectively, and slip sheets P2 are inserted one after every two recording paper sheets P1. When determining that the whole process of image formation based on the print job has been completed (YES in step S16), the controller 10 ends the conveyance speed setting processing.

(2) When a Slip Sheet P2 is Conveyed Before the Conveyance of a Recording Paper Sheet P1, i.e., at the Beginning

It is assumed that the user has input through the touch panel 16B an instruction to select a copy function and has loaded ten sheets of original document on the document loading table of the document conveyance device 6. Furthermore, it is assumed that, through the touch panel 16B, the user has input as a print job print information indicating at least a number of copies, “3”, a sheet type of recording paper sheet P1, “plain paper sheet”, an instruction to insert a slip sheet P2 as a cover sheet, and a sheet type of slip sheet P2, “heavy paper sheet”, and has pressed the Start key 16A.

When detecting the pressing of the Start key 16A, the controller 10 allows the image reading device 11 to read the sheets of original document conveyed sequentially sheet by sheet by the document conveyance device 6 and generate image data representing document images of ten pages, and starts the execution of the conveyance speed setting processing shown in FIGS. 3A and 3B. When starting the conveyance speed setting processing, the controller 10 first sets the current conveyance speed S in the conveyance device 17 at “0” mm/sec (step S10).

In this case, since the controller 10 has accepted the instruction to insert a slip sheet P2 as a cover sheet, the controller 10 sets, as a sheet feed cassette from which a sheet is to be fed first, the sheet feed cassette 14B accommodating slip sheets P2. Therefore, the controller 10 determines, in step S11, that the target to be conveyed is a slip sheet P2 (YES in step S11), determines that the conveyance speed S is set at “0” mm/sec (YES in step S17), and determines whether or not the above-described first instruction has been accepted through the operation device 16 (step S20).

(2-1) When the First Instruction has been Accepted

Here, it is assumed that the controller 10 has previously accepted through the touch panel 16B a first instruction for setting the half-speed mode. In this case, the controller 10 determines that the first instruction has been accepted (YES in step S20), and sets the conveyance speed S at a speed associated with the mode indicated by the first instruction (step S21). In this case, the controller 10 sets the conveyance speed S at “50” mm/sec associated with the half-speed mode. After the processing in step S21, the controller 10 goes to the processing in step S19 and allows the conveyance device 17 to convey the slip sheet P2 at the set conveyance speed S (“50” mm/sec in this case).

(2-2) When a Second Instruction has been Accepted

When determining that the first instruction has not been accepted (NO in step S20), the controller 10 determines whether or not a second instruction for specifying the conveyance speed for the slip sheet P2 has been accepted through the operation device 16 (step S22). Here, it is assumed that the controller 10 has previously accepted, through the touch panel 16B, a second instruction for specifying the conveyance speed for the slip sheet P2 at “150” mm/sec.

In this case, the controller 10 determines that the second instruction has been previously accepted (YES in step S22), and sets the conveyance speed S at a speed associated with the second instruction (step S23). In this case, the controller 10 sets the conveyance speed S at the specified speed, “150” mm/sec. After the processing in step S23, the controller goes to the processing in step S19 and allows the conveyance device 17 to convey the slip sheet P2 at the set conveyance speed S (“150” mm/sec in this case).

(2-3) When Neither First Instruction Nor Second Instruction has been Accepted

When determining that the second instruction has not been accepted (NO in step S22), the controller 10 sets the conveyance speed S according to the sheet type of the slip sheet P2 (step S24). In this case, the controller 10 sets, based on the print information contained in the print job for the slip sheet P2 and indicating a sheet type “heavy paper sheet”, the conveyance speed S at “70” mm/sec associated with the “heavy paper sheet” using the sheet type information stored in the HDD 18. After the processing in step S24, the controller 10 goes to the processing in step S19 and allows the conveyance device 17 to convey the slip sheet P2 at the set conveyance speed S (“70” mm/sec in this case).

After the conveyance of the slip sheet P2, the controller 10 determines that the whole process of image formation based on the print job has not been completed (NO in step S16), and goes to the processing in step S11. Thereafter, the controller 10 repeats the processing in steps S11 to S19 in the same manner as described above to finally create three pieces of printed matter in each of which document images of the first to tenth pages are formed on first to tenth recording paper sheets P, respectively, and a slip sheet P2 is inserted as the cover sheet. When determining that the whole process of image formation based on the print job has been completed (YES in step S16), the controller 10 ends the conveyance speed setting processing.

In the above embodiment, the controller 10 determines the conveyance speed S1 for a recording paper sheet P1 in accordance with the predetermined condition and allows the conveyance device 17 to convey the recording paper sheet P at the determined conveyance speed S1 for the recording paper sheet P1. In allowing the conveyance device 17 to convey the recording paper sheet P1 and subsequently allowing the conveyance device 17 to convey a slip sheet P2, the controller 10 allows the conveyance device 17 to convey the slip sheet P2 at the same speed as the determined conveyance speed S1 for the recording paper sheet P1.

As just described, since the conveyance speed for the slip sheet P2 is set at the same speed as the conveyance speed S1 for the recording paper sheet P1 conveyed previously, there is no need to do control for changing the conveyance speed in conveying the slip sheet P2 after the conveyance of the recording paper sheet P1. Therefore, the number of controls for changing the conveyance speed can be reduced and, as a result, the decrease in print productivity can be prevented.

In the above embodiment, after allowing the conveyance device 17 to convey a recording paper sheet P1, the controller 10 allows the RAM to store the conveyance speed S1 for the recording paper sheet P1 used for the conveyance. In allowing the conveyance device 17 to convey a recording paper sheet P1 after the above conveyance, the controller determines the conveyance speed S1 for the recording paper sheet P1 according to print information indicated in a print job. In allowing the conveyance device 17 to convey a slip sheet P2 after the above conveyance, the controller 10 determines the conveyance speed for the slip sheet P2 according to the conveyance speed S1 for the recording paper sheet P1 stored in the RAM.

Thus, the conveyance speed for the slip sheet P2 can be easily determined to be a value of the conveyance speed S1 for the recording paper sheet P1 conveyed previously. Therefore, the number of controls for changing the conveyance speed can be easily reduced and, as a result, the decrease in print productivity can be easily prevented.

In the above embodiment, when the controller 10 has already accepted a first instruction through the touch panel 16B in allowing the conveyance device 17 to convey a slip sheet P2 before determining the conveyance speed S1 for a recording paper sheet P1, the controller 10 allows the conveyance device 17 to convey the slip sheet P2 at a speed associated with a mode indicated by the first instruction.

As just described, when a slip sheet P2 is conveyed at the beginning, i.e., first, the conveyance speed for the slip sheet P2 is set at the same speed as the conveyance speed for a recording paper sheet P1 to be conveyed next, there is no need to do control for changing the conveyance speed in conveying the recording paper sheet P1 after the conveyance of the slip sheet P2. As a result, the decrease in print productivity can be more certainly prevented.

In the above embodiment, when the controller 10 has already accepted a second instruction through the touch panel 16B in allowing the conveyance device 17 to convey a slip sheet P2 before determining the conveyance speed S1 for a recording paper sheet P1, the controller 10 allows the conveyance device 17 to convey the slip sheet P2 at a speed associated with the second instruction.

As just described, when a slip sheet P2 is conveyed first, the user can specify the conveyance speed for the slip sheet P2 using the operation device 16, which increases the user's convenience.

### OTHER MODIFICATIONS

Although in the above embodiment the controller 10 executes the conveyance speed setting processing in a copying process, the present invention is not limited by the above embodiment. For example, the controller 10 may execute the conveyance speed setting processing in a printing process. In this case, the controller 10 may accept a first instruction or a second instruction through the communication device 22 according to a user's instruction input using the PC 23. In this case, the communication device 22 functions as an input device defined in CLAIMS.

Although in the above embodiment the controller 10 accepts, through the touch panel 16B, a second instruction for directly specifying a value (“150” mm/sec) as the conveyance speed for the slip sheet P2, the present invention is not limited by the above embodiment. For example, the controller 10 may accept, through the touch panel 16B, a second instruction for specifying a “half speed” or a “full speed” as the conveyance speed for the slip sheet P2. The full speed refers to the conveyance speed S1 for the recording paper sheet P1 set according to the print information indicated in the print job for the recording paper sheet P1.

Although in the above embodiment the image forming device 12 and so on form an image on a recording paper sheet P1, the present invention is not limited by the above embodiment. The image forming device 12 and so on may form an image, not only on a recording paper sheet P1, but on other types of recording media. An example of the other types of recording media is an OHP (overhead projector) sheet.

The present invention is not limited to the structure of the above embodiment and can be modified in various ways. For example, although in the above embodiment a multicolor multifunction peripheral is used as the image forming apparatus 1, it is merely illustrative and any other image forming apparatuses, such as a black-and-white multifunction peripheral, a copier, and a facsimile machine, may be used.

The structure, configuration, and processing described in the above embodiment with reference to FIGS. 1 to 3B are merely illustrative and are not intended to limit the present invention to them.

1. An image forming apparatus comprising:
a conveyance device that coveys a recording medium;
an image forming device that forms, on the recording medium conveyed by the conveyance device, an image in accordance with a print job for the recording medium; and
a controller that determines a conveyance speed for the recording medium in accordance with a predetermined condition and allows the conveyance device to convey the recording medium at the determined conveyance speed for the recording medium,
wherein in allowing the conveyance device to convey the recording medium and subsequently allowing the conveyance device to convey a predetermined insert medium, the controller allows the conveyance device to convey the insert medium at the same speed as the determined conveyance speed for the recording medium.

2. The image forming apparatus according to claim 1,
further comprising a storage device,
wherein when allowing the conveyance device to convey the recording medium, the controller allows the storage device to store the conveyance speed for the recording medium used during conveyance of the recording medium,
in allowing the conveyance device to convey the recording medium after the conveyance of a previous recording medium, the controller determines, according to print information indicated in the print job, the conveyance speed for the recording medium to be conveyed, and
in allowing the conveyance device to convey the insert medium after the conveyance of the previous recording medium, the controller determines the conveyance speed for the insert medium according to the conveyance speed for the recording medium stored in the storage device.

3. The image forming apparatus according to claim 1,
further comprising an input device that accepts a user's instruction,
wherein when, in allowing the conveyance device to convey the insert medium before determining the conveyance speed for the recording medium, the controller has already accepted through the input device a first instruction for setting a predetermined mode requiring to change the conveyance speed for the recording medium, the controller allows the conveyance device to convey the insert medium at a speed associated with the mode indicated by the first instruction.

4. The image forming apparatus according to claim 1,
further comprising an input device that accepts a user's instruction,
wherein when, in allowing the conveyance device to convey the insert medium before determining the conveyance speed for the recording medium, the controller has already accepted through the input device a second instruction for specifying a conveyance speed for the insert medium, the controller allows the conveyance device to convey the insert medium at a speed associated with the second instruction.

5. The image forming apparatus according to claim 1, wherein the controller determines the conveyance speed for the recording medium according to a type of the recording medium.

6. The image forming apparatus according to claim 3, wherein when the controller has already accepted the first instruction for setting as the predetermined mode a mode indicating half the conveyance speed for the recording medium, the controller allows the conveyance device to convey the insert medium at half the conveyance speed for the recording medium.
